(19) United States
(12) Patent Application Publication
(10) Pub. No.: US 2023/0030718 A1
(43) Pub. Date: Feb. 2, 2023

(54) RECORDING OF PART FABRICATION PARAMETERS IN BLOCKCHAIN LEDGERS

(71) Applicant: Hewlett-Packard Development Company, L.P., Spring, TX (US)

(72) Inventors: Yelena Helen BALINSKY, Bristol (GB); Andre RABELO, Sant Cugat del Valles (ES); Scott Alan WHITE, Boise, ID (US)

(73) Assignee: Hewlett-Packard Development Company, L.P., Spring, TX (US)

(21) Appl. No.: 17/390,349

(22) Filed: Jul. 30, 2021

(51) Int. Cl. G05B 19/406; G06F 16/23; B33Y 50/00; B29C 64/386

(52) U.S. Cl. CPC G05B 19/406; B29C 64/386; B33Y 50/00; G06F 16/2379; G05B 2219/49023

(57) ABSTRACT

According to examples, a three-dimensional (3D) fabrication system may include a fabrication component, a monitoring component, and a controller. The controller may access a record specifying an identification of a parameter to be monitored during a fabrication operation of a part, cause the fabrication component to fabricate the part, and cause the monitoring component to monitor the parameter during fabrication of the part and generate data corresponding to the monitored parameter. The controller may also cause the generated data to be recorded in a blockchain ledger.

### BACKGROUND

Three-dimensional (3D) fabrication systems may be employed to fabricate parts through implementation of additive manufacturing processes. Some 3D fabrication systems fabricate the parts through formation of sections of the parts in successive layers of materials.

### BRIEF DESCRIPTION OF DRAWINGS

Features of the present disclosure are illustrated by way of example and not limited in the following figure(s), in which like numerals indicate like elements, in which:

FIGS. 1 and 2, respectively show block diagrams of an example three-dimensional (3D) fabrication system, in which a controller may cause data corresponding to a parameter monitored during fabrication of a part to be recorded in a blockchain ledger;

FIG. 3 depicts a block diagram of an example system for securely tracking and certifying a parameter monitored during 3D fabrication of a part;

FIG. 4 depicts a flow diagram of a method for determining whether a parameter monitored during fabrication of a part falls within a predefined range and recording an indication corresponding to the determination in a blockchain ledger; and

FIG. 5 shows a block diagram of an example computer-readable medium that may have stored thereon computer-readable instructions for determining whether a parameter monitored during fabrication of a part falls within a predefined range and recording an indication corresponding to the determination in a blockchain ledger.

### DETAILED DESCRIPTION

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the examples. Furthermore, the examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

The quality, such as, physical attributes and/or appearance attributes, of 3D fabricated parts may be affected by various parameters that may exist during the fabrication of the parts. For instance, if build materials fail to reach certain temperatures during fabrication of the parts, the build materials may not sufficiently fuse together and the parts may have inadequate strengths. As another example, if the humidity level inside of a build chamber of a 3D fabrication system exceeds certain levels, the build materials may also not sufficiently fuse together properly. These physical attributes of the fabricated parts may not be readily identifiable through a visual inspection of the parts.

In some instances, to guarantee that the parts have certain levels of quality, some of the parameters, e.g., conditions, that the build materials may have undergone during formation of the parts may be monitored and stored, for instance, in a database. These parameters may be accessed to determine whether the build materials may have experienced adverse conditions during fabrication of the parts, which may be an indication that the parts may have lower than expected quality levels. In some instances, however, the data pertaining to the parameters may be falsified to make it appear that the parameters experienced by the build materials are within normal ranges or are outside of normal ranges. This may occur even in instances in which the data pertaining to the parameters are protected through use of safety measures such as encryption and/or password protections as the passwords may be stolen or otherwise illicitly obtained.

An issue with conventional techniques of storing data pertaining to parameters monitored during fabrication of parts is that the data may relatively easily be modified. Additionally, the data may be modified in a concealed manner and thus, the modification of the data may not be readily determined. As a result, a guaranteed quality of parts may not be determined from the data.

Disclosed herein are 3D fabrication systems, methods, and computer-readable media, in which data pertaining to the parameters, e.g., conditions, that build materials may have undergone during fabrication of parts from the build materials may securely be recorded. Particularly, the data pertaining to the conditions may be recorded as secure blocks, e.g., transactions, in a blockchain ledger. For instance, the recorded blocks may include cryptographic hashes of prior blocks, which may make tampering of the records of the data pertaining to the conditions to be relatively difficult or impossible. Additionally, determinations as to whether the monitored parameters comply with predefined parameter ranges may be made and indications of the determinations may also be recorded as blocks in the blockchain ledger.

Through implementation of the features of the present disclosure, as the data pertaining to parameters monitored during a fabrication operation, e.g., an additive fabrication operation, of a part may not readily be modified, the accuracy of the data may be guaranteed. In some instances, the accuracy of the data may also be certified and the certification may be recorded in a manner that may not readily be modified. As discussed herein, a technical issue associated with conventional manners of storing data pertaining to parameters monitored during a part fabrication operation may be that the data may be manipulated in a concealed manner and thus, the data may not be trustworthy. As a result, additional processing resources may need to be employed to determine whether the data has been modified, for instance, by accessing data from other sources if such other sources exist. A technical improvement afforded through implementation of the features of the present disclosure may be that the data pertaining to the parameters may be guaranteed and thus, additional processing resources may not need to be implemented to verify the accuracy of the data.

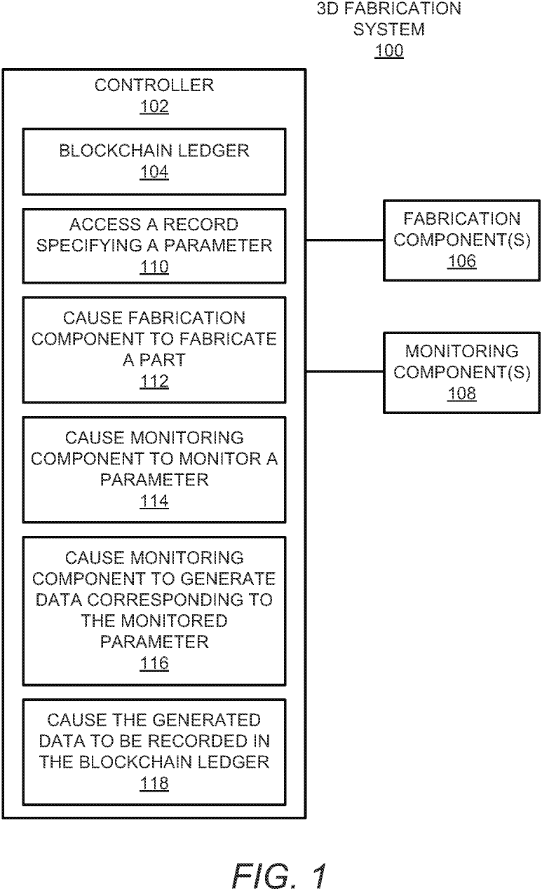

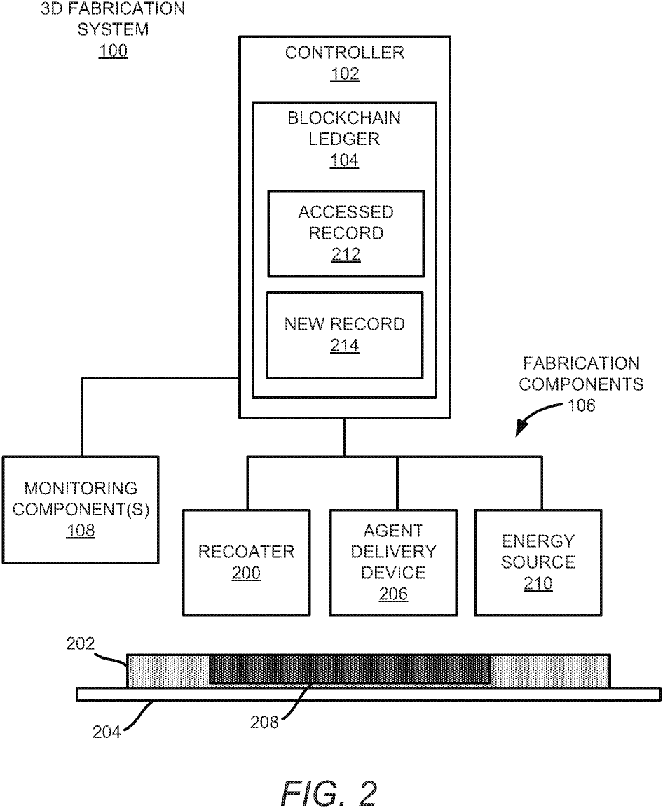

Reference is first made to FIGS. 1 and 2, which respectively show block diagrams of an example three-dimensional (3D) fabrication system 100, in which a controller 102 may cause data corresponding to a parameter monitored during fabrication of a part to be recorded in a blockchain ledger 104. It should be understood that the example 3D fabrication system 100 may include additional features and that some of the features described herein may be removed and/or modified without departing from the scope of the 3D fabrication system 100.

Generally speaking, the three-dimensional (3D) fabrication system 100 may be any suitable type of additive manufacturing system. Examples of suitable additive manufacturing systems may include systems that may employ curable binder jetting onto build materials (e.g., thermally or UV curable binders), print agent jetting onto build materials (e.g., fusing and/or detailing agents), selective laser sintering, stereolithography, fused deposition modeling, etc. In a particular example, the 3D fabrication system 100 may form parts by binding and/or fusing build material particles together. In any of these examples, the build material particles may be any suitable type of material that may be employed in 3D fabrication processes, such as, a metal, a plastic (such as a nylon), a ceramic, an alloy, and/or the like.

As shown in FIG. 1, in addition to the controller 102, the 3D fabrication system 100 may include a fabrication component 106 (or multiple fabrication components 106) and a monitoring component 108 (or multiple monitoring components 108). The controller 102 may execute instructions 110 to access a record specifying an identification of a parameter to be monitored during a fabrication operation by the fabrication component(s) 106 of a part. The controller 102 may also execute instructions 112 to cause the fabrication component(s) 106 to fabricate the part. In addition, the controller 102 may execute instructions 114 to cause the monitoring component(s) 108 to monitor the parameter during fabrication of the part.

The controller 102 may execute instructions 116 to cause the monitoring component(s) 108 to generate data corresponding to the parameter monitored by the monitoring component(s) 108 during fabrication of the part. For instance, the monitoring component(s) 108 may convert or otherwise cause the monitored parameter to be in a form (e.g., data) that may be machine-readable, readily stored, processed, and/or the like. In addition, the monitoring component(s) 108 may store the data or may not store the data corresponding to the monitored parameter depending, for instance, on whether the monitored parameter meets certain requirements. By way of example in which the monitored parameter is process temperature, the monitoring component(s) 108 may take measurements at certain intervals of time, e.g., 10 seconds or the like, and may determine whether the measured temperatures fall within a certain intended range. The monitoring component(s) 108 may record all of the measured temperatures and, if the measured temperatures fall within the certain intended range, then the measured temperatures may be reported together at the end of the process as a stream or in batches. In another example, the monitoring component(s) 108 may record the minimum (MIN) measured temperature, the maximum (MAX) measured, the average measured temperature, and/or the like. In addition, these values may be recomputed as new measured temperatures are collected and may be reported at the end of the process. Additionally, if an abnormal measurement is encountered, for instance, if a temperature measurement falls outside of the certain intended range, an immediate report may be outputted.

The controller 102 may execute instructions 118 to cause the generated data to be recorded in the blockchain ledger 104. The blockchain ledger 104 may be a publicly distributed ledger and the generated data may be recorded as a block in the blockchain ledger 104. In addition, the controller 102 may record the generated data as a block that is linked together with a previous block in the blockchain ledger 104. For instance, the controller 102 may generate the block containing the generated data to also include a cryptographic hash of the previous block to form a chain. In one regard, by recording the data pertaining to the monitored parameter as a linked block in the blockchain ledger 104, the data may be stored in a manner that is resistant to manipulation and/or in a manner that enables manipulations to be readily identifiable.

The controller 102, which may control operations of the 3D fabrication system 100, may be a semiconductor-based microprocessor, a central processing unit (CPU), an application specific integrated circuit (ASIC), a field-programmable gate array (FPGA), and/or other hardware device. In some examples, the instructions 110-118 may be stored as software on the controller 102 while in other examples, the instructions 110-118 may be stored as machine-readable instructions on a memory (not shown) that the controller 102 may access. The memory, which may also be termed a computer readable medium, may be, for example, a Random Access memory (RAM), an Electrically Erasable Programmable Read-Only Memory (EEPROM), a storage device, or the like. The memory may be a non-transitory computer readable storage medium, where the term “non-transitory” does not encompass transitory propagating signals.

With reference now to FIG. 2, the fabrication components 106 are shown as including a plurality of components that the controller 102 may control. As shown, the fabrication components 106 may include a recoater 200 that may spread respective layers of build material particles 202 over a build platform 204. The fabrication components 106 may also include an agent delivery device 206, e.g., a printhead or other suitable type of device, that the controller 102 may control to selectively deliver a binding agent and/or a fusing agent onto the layers of the build material particles 202.

The fabrication components 106 may further include an energy source 210 that may apply energy onto the layers of build material particles 202 to cause the build material particles 202 upon which the agent has been deposited to bind together. The energy source 210 may apply energy as a focused beam, e.g., a laser beam, or across a larger surface area, e.g., as ultra-violet energy, as heat, and/or the like. For instance, the controller 102 may control the agent delivery device 206 to deliver an agent onto selected areas of the layers of the build material particles 202 such that the build material particles 202 upon which the agent is delivered is to be formed into a part 208 following application of the energy.

According to examples, the controller 102 may cause or control the monitoring component(s) 108 to monitor a parameter during fabrication of the part 208 by the fabrication component(s) 106. In some examples, the parameter may be, for instance, temperatures on or around the layers of build material particles 202 during a fabrication operation of the part 208. The temperatures may be monitored at multiple locations across the layers of build material particles 202 during the fabrication operation. In these examples, the monitoring component 108 may include a thermal camera, thermistors, thermometers, and/or the like.

In some examples, the parameter may be air pressures and/or airflows in a space, e.g., a chamber, a build volume, and/or the like, within which the part 208 may be formed from the layers of build material particles 202. In these examples, the monitoring component 108 may be an air pressure sensor. In addition or in other examples, the parameter may be humidity within the space and the monitoring component 108 may be a humidity sensor.

In some examples, the parameter may be geometries of portions of the part 208 during formation of the part 208. In these examples, the monitoring component 108 may be an imaging camera, such as a 3D imaging camera that may capture contours of surfaces of the layers of build material particles 202. The geometries, e.g., contours, peaks, valleys, and/or the like, of the surfaces of the layers of build material particles 202 during fabrication of the part 208 may be identified from the images captured by the monitoring component 108. In addition, the heights of the portions of the layers of build material particles 202 may be determined from the captured images.

The 3D fabrication system 100 may include multiple monitoring components 108. In some examples, the controller 102 may activate each of the monitoring components 108 during a fabrication operation of the part 208. In other examples, the controller 102 may activate the monitoring component 108 that is to monitor the parameter specified in an accessed record 212. For instance, the controller 102 may have accessed, e.g., received, retrieved, obtained, and/or the like, a record 212 specifying an identification of a parameter to be monitored during a fabrication operation of the part 208. The record 212 may be recorded in the blockchain ledger 104, for instance, as a linked block in the blockchain ledger 104, and the controller 102 may access the record 212 from the blockchain ledger 104.

According to examples, a user or other entity may have added the record 212 in the blockchain ledger 104. For instance, the user or other entity may have generated a cryptographic hash of the identification of the parameter to be monitored as well as a cryptographic hash of a previous block to generate the record 212 as a block in the blockchain ledger 104. The user or other entity may have generated the cryptographic hash of the identification of the parameter to be monitored using a set of private and shared credentials, e.g., keys. In addition, the controller 102 may decrypt the record 212 using a set of shared and private credentials, e.g., keys, to access the identification of the parameter to be monitored specified in the record 212. The controller 102 may also access the previous block hash value of the previous block (record 212) from the decrypted version of the record 212.

In some examples, the controller 102 may apply a hash to the generated data and the previous block hash value of the previous block (record 212) to generate a block hash value for the generated data. In addition, the controller 102 may record the generated data, the previous block hash value of the previous block (record 212), and the block hash value as a new record 214 in the blockchain ledger 104.

In accessing the data corresponding to the monitored parameter, the controller 102 may compile data corresponding to the monitored parameter at multiple time periods during fabrication of the part 208. For instance, the monitoring component(s) 108 may store the monitored parameters over the multiple time periods during fabrication of the part 208 in a data store (not shown). The controller 102 may also compile the data from the data stored in the data store. In addition, the controller 102 may cause the compiled data to be recorded as the new record 214 in the blockchain ledger 104.

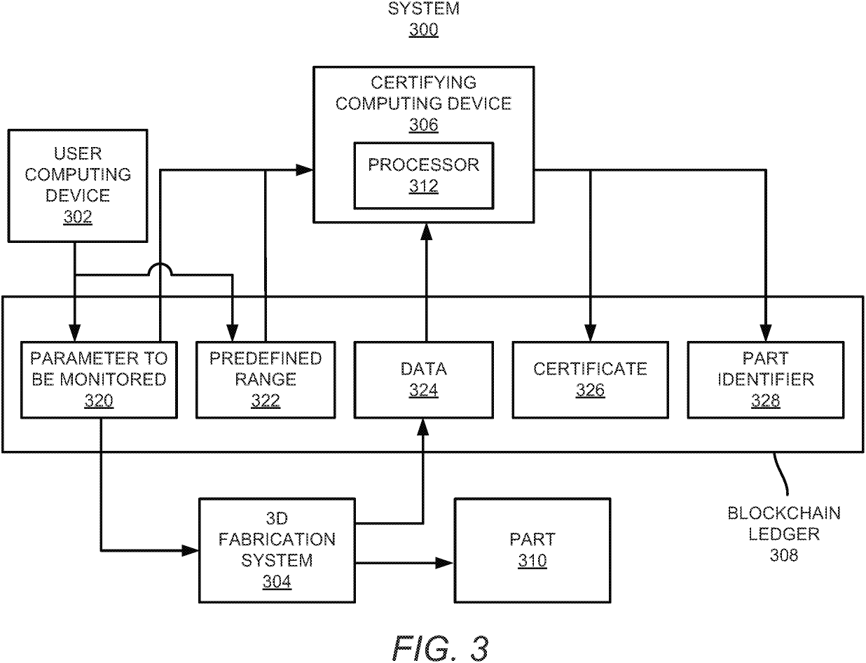

Turning now to FIG. 3, there is shown a block diagram of an example system 300 for securely tracking and certifying a parameter monitored during 3D fabrication of a part 208. It should be understood that the example system 300 may include additional features and that some of the features described herein may be removed and/or modified without departing from the scope of the system 300.

As shown in FIG. 3, the system 300 may include a user computing device 302, a 3D fabrication system 304, and a certifying computing device 306. The system 300 may also include a blockchain ledger 308, which may be distributed across the user computing device 302, the 3D fabrication system 304, and the certifying computing device 306 as a peer-to-peer network. In addition, each of the user computing device 302, the 3D fabrication system 304, and the certifying computing device 306 may authenticate each other, for instance, through use of public and private credentials, e.g., public keys and private keys.

The user computing device 302 may be a computing device of a user, e.g., a customer, that seeks to have a part 310 fabricated by the 3D fabrication system 304. The user computing device 302 may record a record 320 that may specify an identification of a parameter to be monitored during a fabrication operation of the part 310 into the blockchain ledger 308. The user computing device 302 may also record a record 322 that may specify an identification of a predefined range for the parameter to be monitored into the blockchain ledger 308. The user computing device 302 may record the records 320, 322 as linked blocks in the blockchain ledger 308, e.g., the records 320, 322 may include cryptographic hashes of respective prior blocks.

The predefined range for the parameter may be a range within which the parameter is to remain during fabrication of the part 310 such that the part 310 is fabricated with an intended level of quality. In other words, when the parameter falls outside of the predefined range during fabrication of the part 310, the quality level of the part 310 may not be guaranteed. By way of particular example in which the parameter is temperature, the predefined range may include an upper temperature level and a lower temperature level. As another example in which the parameter is height, the predefined range may include an upper height limit and a lower height limit.

As shown in FIG. 3, the 3D fabrication system 304 may access the record 320 that may specify the parameter to be monitored. The 3D fabrication system 304 may also fabricate the part 310 and may monitor the parameter during fabrication of the part 310. In some examples, the 3D fabrication system 304 may be similar to the 3D fabrication system 100 discussed above with respect to FIGS. 1 and 2. The 3D fabrication system 304 may thus fabricate the part 310 and may monitor the parameter as discussed above with respect to the 3D fabrication system 100. The 3D fabrication system 304 may also record a record 324 that may specify data corresponding to the monitored parameter as a block in the blockchain ledger 308. The 3D fabrication system 304 may record the record 324 as also discussed herein with respect to FIGS. 1 and 2.

As further shown in FIG. 3, the certifying computing device 306 may access the record 320 that may specify the parameter to be monitored, the record 322 that may specify the predefined range for the parameter, and the record 324 that may specify data corresponding to the monitored parameter. The certifying computing device 306 may decrypt each of the records 320, 322, and 324 to access the information contained in those records 320, 322, 324. In addition, the certifying computing device 306, and particularly, a processor 312 of the certifying computing device 306 may determine whether the parameter monitored during the fabrication operation of the part 310 falls within the predefined range. The processor 312 may be a semiconductor-based microprocessor, a central processing unit (CPU), an application specific integrated circuit (ASIC), a field-programmable gate array (FPGA), and/or other hardware device.

The processor 312 may also record a record 326 of a certificate that may indicate whether the monitored parameter falls within the predefined range or falls outside of the predefined range in the blockchain ledger 308. The certifying computing device 306 may also record a record 328 that may identify a part identifier of the part 310 in the blockchain ledger 308.

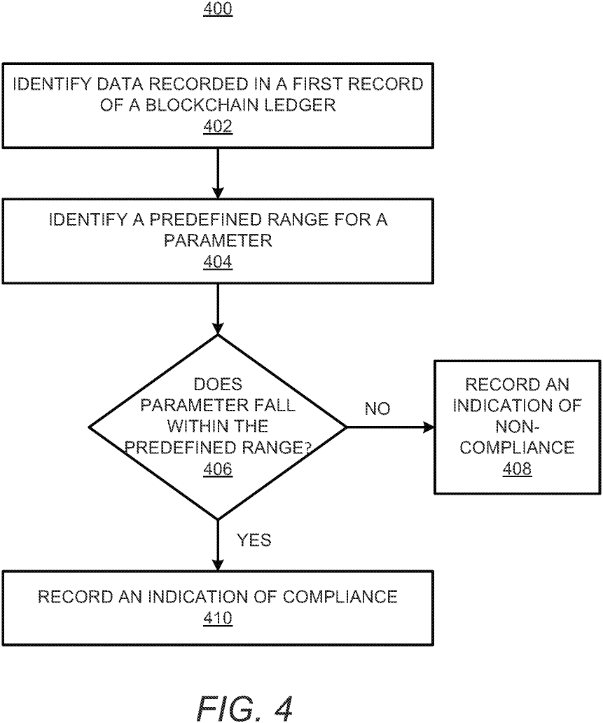

Various manners in which the processor 312 of the certifying computing device 306 may operate are discussed in greater detail with respect to the method 400 depicted in FIG. 4. Particularly, FIG. 4 depicts a flow diagram of an example method 400 for determining whether a parameter monitored during fabrication of a part 310 falls within a predefined range and recording an indication corresponding to the determination in a blockchain ledger 308. It should be understood that the method 400 may include additional operations and that some of the operations described therein may be removed and/or modified without departing from the scope of the method 400. The description of the method 400 are made with reference to the features depicted in FIGS. 1-3 for purposes of illustration. In addition, the use of the terms “first,” “second,” “third,” and so forth throughout the present disclosure should not be construed as denoting order, but instead, these terms are used herein to distinguish certain features from each other.

At block 402, the processor 312 may identify data recorded in a first record 324 of a blockchain ledger 308. The data may correspond to a parameter monitored during a fabrication operation of a part 310. in addition, at block 404, the processor 312 may identify a predefined range for the parameter recorded in a second record 322 of the blockchain ledger 308. The processor 312 may access the records 322, 324 by retrieving the records 322, 324 from the blockchain ledger 308.

At block 406, the processor 312 may determine whether the parameter monitored during the fabrication operation of the part 310 falls within the predefined range. In addition, at blocks 408 and 410, the processor 312 may record an indication as to whether the parameter monitored during the fabrication operation of the part 310 falls within the predefined range as a third record 326 of the blockchain ledger 308. That is, based on a determination that the parameter falls outside of the predefined range, at block 408, the processor 312 may record an indication of non-compliance, e.g., a certificate of non-compliance, as the third record 326. However, based on a determination that the parameter falls within the predefined range, at block 410, the processor 312 may record an indication of compliance, e.g., a certificate of compliance, as the third record 326.

According to examples, the processor 312 may apply a cryptographic hash to the indication as to whether the parameter monitored during the fabrication operation of the part 310 falls within the predefined range and a hash value of a previous record of the blockchain ledger 308 to generate a third record hash value. In addition, the processor 312 may record the indication, the hash value of the previous record, and the third record hash value as the third record 326 of the blockchain ledger 308.

According to examples, the processor 312 may access an identifier of the fabricated part 310. In addition, the processor 312 may record the identifier of the fabricated part 310 as a fourth record 328 of the blockchain ledger 308.

Some or all of the operations set forth in the method 400 may be included as utilities, programs, or subprograms, in any desired computer accessible medium. In addition, the method 400 may be embodied by computer programs, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

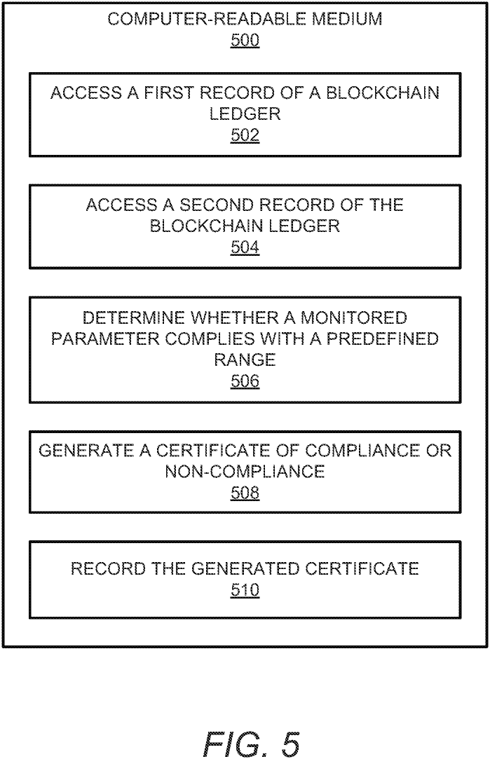

Turning now to FIG. 5, there is shown a block diagram of an example computer-readable medium 500 that may have stored thereon computer-readable instructions for determining whether a parameter monitored during fabrication of a part 310 falls within a predefined range and recording an indication corresponding to the determination in a blockchain ledger 308. It should be understood that the computer-readable medium 500 depicted in FIG. 5 may include additional instructions and that some of the instructions described herein may be removed and/or modified without departing from the scope of the computer-readable medium 500 disclosed herein. The computer-readable medium 500 may be a non-transitory computer-readable medium, in which the term “non-transitory” does not encompass transitory propagating signals.

The computer-readable medium 500 may have stored thereon computer-readable instructions 502-510 that a processor, such as the processor 312 of the certifying computing device 306 depicted in FIG. 3, may execute. The computer-readable medium 500 may be an electronic, magnetic, optical, or other physical storage device that contains or stores executable instructions. The computer-readable medium 500 may be, for example, Random Access memory (RAM), an Electrically Erasable Programmable Read-Only Memory (EEPROM), a storage device, an optical disc, and the like.

The processor may fetch, decode, and execute the instructions 502 to access a first record 324 of a blockchain ledger 308, in which data corresponding to a parameter monitored during a fabrication operation of a part 310 is recorded in the first record 324. The processor may fetch, decode, and execute the instructions 504 to access a second record 322 of the blockchain ledger 308, in which a predefined range for the parameter is recorded in the second record 322. The processor may fetch, decode, and execute the instructions 506 to determine whether the parameter monitored during the fabrication operation of the part complies with the predefined range. The processor may fetch, decode, and execute the instructions 508 to generate a certificate of compliance or a certificate of non-compliance based on the determination as to whether the parameter monitored during the fabrication operation of the part complies with the predefined range. In addition, the processor may fetch, decode, and execute the instructions 502 to record the generated certificate of compliance or certificate of non-compliance as a third record 326 of the blockchain ledger 308.

According to examples, the processor may apply a hash to the generated certificate of compliance or certificate of non-compliance and a hash value of a previous record of the blockchain ledger to generate a third record hash value. In addition, the processor may record the generated certificate of compliance or certificate of non-compliance, the hash value of the previous record, and the third record hash value as the third record 326 of the blockchain ledger 308.

According to examples, the processor may access an identifier of the fabricated part 310 and may record the identifier of the fabricated part as a fourth record 328 of the blockchain ledger 308. For instance, the processor may apply a hash to the identifier of the fabricated part and a hash value of a previous record, e.g., record 326, of the blockchain ledger 308 to generate a fourth record hash value. In addition, the processor may record the identifier, the hash value of the previous record, and the fourth record hash value as the fourth record 328 of the blockchain ledger 308.

Although described specifically throughout the entirety of the instant disclosure, representative examples of the present disclosure have utility over a \wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims -- and their equivalents -- in which all terms are meant in their broadest reasonable sense unless otherwise indicated.

What is claimed is:

1. A three-dimensional (3D) fabrication system comprising:
a fabrication component;
a monitoring component; and
a controller to:
access a record specifying an identification of a parameter to be monitored during a fabrication operation of a part;
cause the fabrication component to fabricate the part;
cause the monitoring component to:
monitor the parameter during fabrication of the part; and
generate data corresponding to the monitored parameter; and
cause the generated data to be recorded in a blockchain ledger.

2. The 3D fabrication system of claim 1, wherein the record specifying the identification of the parameter to be monitored is recorded in the blockchain ledger and wherein the controller is to:
access the record specifying the identification of the parameter to be monitored from the blockchain ledger.

3. The 3D fabrication system of claim 1, wherein, to cause the generated data to be recorded in the blockchain ledger, the controller is to:
apply a hash to the generated data and a previous block hash value of a previous block in the blockchain ledger to generate a block hash value; and
record the generated data, the previous block hash value, and the block hash value as a new record in the blockchain ledger.

4. The 3D fabrication system of claim 1, further comprising:
multiple monitoring components to monitor multiple respective parameters; and
wherein the controller is to:
activate the monitoring component of the monitoring components that is to monitor the parameter specified in the accessed record, wherein the monitoring component is to generate data corresponding to the monitored parameter.

5. The 3D fabrication system of claim 1, wherein the parameter to be monitored comprises a temperature, air pressure, humidity, airflow, or a geometry of portions of the part monitored during fabrication of the part.

6. The 3D fabrication system of claim 1, wherein the controller is to compile data corresponding to the monitored parameter at multiple time periods during fabrication of the part and to cause the compiled data to be recorded as a new record in the blockchain ledger.

7. A method comprising:
identifying, by a processor, data recorded in a first record of a blockchain ledger, the data corresponding to a parameter monitored during a fabrication operation of a part;
identifying, by the processor, a predefined range for the parameter recorded in a second record of the blockchain ledger;
determining, by the processor, whether the parameter monitored during the fabrication operation of the part falls within the predefined range; and
recording, by the processor, an indication as to whether the parameter monitored during the fabrication operation of the part falls within the predefined range as a third record of the blockchain ledger.

8. The method of claim 7, further comprising:
applying a hash to the indication as to whether the parameter monitored during the fabrication operation of the part falls within the predefined range and a hash value of a previous record of the blockchain ledger to generate a third record hash value; and
recording the indication, the hash value of the previous record, and the third record hash value as the third record of the blockchain ledger.

9. The method of claim 7, further comprising:
based on a determination that the parameter monitored during the fabrication operation of the part falls within the predefined range,
generating a certificate of compliance; and
recording the certificate of compliance as the third record of the blockchain ledger; and
based on a determination that the parameter monitored during the fabrication operation of the part falls outside of the predefined range,
generating a certificate of non-compliance; and
recording the certificate of non-compliance as the third record of the blockchain ledger.

10. The method of claim 7, further comprising:
accessing an identifier of the fabricated part; and
recording the identifier of the fabricated part as a fourth record of the blockchain ledger.

11. The method of claim 7, wherein the parameter comprises a temperature, air pressure, airflow, or a geometry of portions of the part monitored during the fabrication operation of the part.

12. A non-transitory computer-readable medium on which is stored computer-readable instructions that when executed by a processor, cause the processor to:
access a first record of a blockchain ledger, wherein data corresponding to a parameter monitored during a fabrication operation of a part is recorded in the first record;
access a second record of the blockchain ledger, wherein a predefined range for the parameter is recorded in the second record;
determine whether the parameter monitored during the fabrication operation of the part complies with the predefined range;
generate a certificate of compliance or a certificate of non-compliance based on the determination as to whether the parameter monitored during the fabrication operation of the part complies with the predefined range; and
record the generated certificate of compliance or certificate of non-compliance as a third record of the blockchain ledger.

13. The non-transitory computer-readable medium of claim 12, wherein the instructions further cause the processor to:
apply a hash to the generated certificate of compliance or certificate of non-compliance and a hash value of a previous record of the blockchain ledger to generate a third record hash value; and
record the generated certificate of compliance or certificate of non-compliance, the hash value of the previous record, and the third record hash value as the third record of the blockchain ledger.

14. The non-transitory computer-readable medium of claim 12, wherein the instructions further cause the processor to:
access an identifier of the fabricated part; and
record the identifier of the fabricated part as a fourth record of the blockchain ledger.

15. The non-transitory computer-readable medium of claim 14, wherein the instructions further cause the processor to:
apply a hash to the identifier of the fabricated part and a hash value of a previous record of the blockchain ledger to generate a fourth record hash value; and
record the identifier, the hash value of the previous record, and the fourth record hash value as the fourth record of the blockchain ledger.
